(19) United States
(12) Patent Application Publication
(10) Pub. No.: US 2024/0417824 A1
(43) Pub. Date: Dec. 19, 2024

(54) SOLVENTS AND METHODS FOR LEACHING PRECIOUS METALS

(71) Applicant: PH7 TECHNOLOGIES INC., BurnaBy (CA)

(72) Inventors: Mohammad DOOSTMOHAMMADI, North Vancouver (CA); Moghadam ZADEH, North Vancouver (CA); Ryan John ROBERTS, Vancouver (CA)

(21) Appl. No.: 18/703,570

(22) PCT Filed: Oct. 21, 2022
(86) PCT No.: PCT/CA2022/051558

§ 371 Date: Apr. 22, 2024

Related U.S. Application Data
(60) Provisional application No. 63/271,034, filed on Oct. 22, 2021.

(51) Int. Cl. C22B 3/16; C22B 3/22; C22B 11/00

(52) U.S. Cl. CPC C22B 3/1608; C22B 3/22; C22B 11/04

(57) ABSTRACT

A recyclable, non-toxic solvent media and methods for precious metal leaching and extraction, in particular platinum group metals (PGMs), are described. The solvent media comprises 3-methoxy-3-methyl-1-butanol (MMB), an oxidizing agent such as lithium bromate, and a halogen salt such as lithium bromide. A precious metal leaching process comprises preparing the solvent media, adding precious metal-containing substance to the solvent media and agitation to leach the precious metal from the substance into the solvent. Agitation may be performed for several hours to days at relatively low temperature. After leaching, filtration is performed to separate the solvent-soluble precious metals from insoluble residues. The method may further comprise refinement of the precious metal and purification of the solvent. Purified solvent may be recycled/reused in solvent media for leaching and extraction of precious metals.

### TECHNICAL FIELD

The present disclosure relates generally to a method for leaching precious metals and more particularly relates to leaching precious metals using non-toxic, and non-aqueous solvents.

### INTRODUCTION

Precious metals, including gold, silver, and platinum group metals or PGMs, are one group of strategic metals globally. For example, PGMs play an essential role in reducing greenhouse and toxic gases because of their catalytic characterizations. As more strict environmental regulations are being implemented around the world, the demand for sustainable PGMs production has been increasing significantly to meet the new environmental policies. The PGMs high economic value and irreplicable technological and catalytic properties, as well as their scarcity in the Earth's crust, justify concerns about their critical condition and reinforce the importance of developing economic and eco-friendly recycling and extraction practices for PGMs bearing materials (i.e., mine concentrate, end-of-life materials, etc.).

Extraction of precious metals from mining concentrates and tailings and precious metal recycling from end-of-life materials are of great importance in the industry. They are pyrometallurgy, hydrometallurgy and hybrid techniques to extract precious metals from different resources.

Many methods have been used or been proposed to extract precious metals from primary or secondary sources. These techniques typically use strong acids (e.g., HCl, HNO₃) and/or toxic organic compounds (e.g., cyanides) and high temperature (e.g., >100° C.) to leach and extract precious metals (see U.S. Pat. No. 11,427,886, European Patent No. 1501952 and Chinese Patent Publication No. 112280983). Capital intensity, high operating costs and strict environmental regulations limit the implementation of conventional metallurgical processing options, particularly smelter-based operations in the extraction of precious metals. Thus, new approaches that are safer and less toxic are desired to extract precious metals.

One of the most promising recent suggested processes for the extraction of metals is solvometallurgy. In this process, green (i.e., non-toxic) and biodegradable solvents are applied for the selective extraction of metals. In this new branch of metallurgy, the solvent used in the extraction of metal is non-aqueous, which will result in minimal wastewater. In sustainable solvometallurgical methods, green solvents are being used which are non-toxic or harmful and are biodegradable and thus bare minimal environmental impact. The main benefits of solvometallurgy include limited water consumption, decreased energy consumption, nearly zero acid consumption, improved leaching selectivity, suitability for low-grade ore, less formation of silica gel and suitable for urban waste treatment.

The selection of a proper solvent is essential in solvometallurgy. Moreover, the choice of the best solvent does not depend solely on its dissolving performance, and other important criteria such as stability, recycling ability, economics, environmental impacts, safety, and toxicity should be considered. The sustainability of the solvometallurgical process depends on solvent selection. It is desired that not any harmful or dangerous solvents can be used in solvometallurgy even if they have a good performance in the leaching and extraction process.

Accordingly, there is a need for novel non-toxic biodegradable solvents for solvometallurgy, in particular, for PGMs.

### SUMMARY

An objective of this disclosure is to present a sustainable and economic solvometallurgical extraction process for precious metals from precious metal-containing substances while increasing precious metal recovery and precious metal recycling feasibility. To maximize the reactivity of precious metals with reagents, an organic solvent media is described with the ability to dissolve precious metals selectively. The solvent media has properties desirable for safety, health and environmental criteria.

This disclosure focuses on a solvent media comprising a solvent containing 3-methoxy-3-methyl-1-butanol (MMB), an oxidizing agent such as lithium bromate, and a halogen salt such as lithium bromide. The solvent media presents an organic media which maximizes solubility of halogens in their oxidizing phase, which prevents halogen evaporation but also increases the reactivity of halogens with targeted metals in the solvent media. The solvent media is a green and biodegradable solvent with no flash point to leach and extract precious metals in a safe and sustainable manner. The reusability of the solvent will enable the precious metal leaching process to be performed in a closed-loop system with no effluent.

Moreover, the present disclosure provides a method for extracting precious metals, including gold, silver, and platinum group metals.

According to an embodiment, there is a solvent media for leaching precious metals. The solvent media comprises a solvent comprising 3-methoxy-3-methyl-1-butanol (MMB), an oxidizing agent; and a halogen salt. The oxidizing agent may be chlorine, bromine, bromate, perbromate salt, hydrogen peroxide, chlorate or chlorite salts. The halogen salt may be an alkali metal bromide salt or an alkali chloride salt and is preferably one of lithium bromide, sodium bromide and potassium bromide. The solvent media has an oxidation reduction potential of >600 mV and a pH of 1 to 4 and more preferably 1 to 3.

According to another embodiment, there is a precious metal extraction process comprising the following stages: (1) solvent preparation; (2) leaching; and (3) filtering/extraction.

During the leaching stage, a substance containing precious metals is added to the disclosed solvent media and forms a slurry with pulp density of around 10% and no more than 25% w/w. The slurry comprises a precious metal-pregnant solution and insoluble impurities. During the filtering stage, the insoluble impurities are separated from the precious metal-pregnant solution and the precious metals are extracted from the precious metal=pregnant solution. The process may also include a solvent purification stage to recycle the used solvent in the leaching stage.

Other aspects and features will become apparent to those ordinarily skilled in the art upon reviewing the following description of specific disclosed embodiments in conjunction with the accompanying figures.

### BRIEF DESCRIPTION OF THE DRAWINGS

The drawings included herewith are for illustrating various examples of articles, methods, and apparatuses of the present specification. In the drawings:

FIG. 1 is a flow chart of a precious metal leaching process, according to an embodiment;

FIG. 2 is a flow chart of a precious metal extraction process, according to an embodiment;

FIG. 3A is a graph comparing the amount of Platinum dissolution, over time, using aqua regia vs. a solvent of the current disclosure;

FIG. 3B is a graph comparing the amount of Palladium dissolution, over time, using aqua regia vs. a solvent of the current disclosure;

FIG. 3C is a graph comparing the amount of Rhodium dissolution, over time, using aqua regia vs. a solvent of the current disclosure; and

FIG. 4 is a comparative study showing the effect of oxidant (by weight %) in Platinum recovery.

### DETAILED DESCRIPTION

Various compositions or processes will be described below to provide an example of each claimed embodiment. No embodiment described below limits any claimed embodiment and any claimed embodiment may cover processes or compositions that differ from those described below. The claimed embodiments are not limited to compositions or processes having all of the features of any one composition or process described below or to features common to multiple or all of the compositions described below.

It is an object of the present disclosure to introduce new methods to extract precious metals from precious metal containing substances using a novel leaching method that includes applying green (non-toxic and biodegradable), non-aqueous solvent, and reagents/additives to maximize the solubility of PGMs. The proposed solvent includes 3-methoxy-3-methyl-1-butanol, referred to as “MMB” hereinafter. The precious metal-containing substances may be primary resources such as mining extracts including concentrates or tailing ore or secondary resources such as recycled materials including spent automotive catalysts.

The method of current disclosure can be applied to the dissolution of precious metals, whereby precious metals shall be understood to be elements Au, Ag, Pd, Pt, Ir, Rh, Ru, and Os. Also, Platinum group metals including Pd, Pt, Ir, Rh, Ru, and Os are referred to as PGM or PGMs hereinafter.

The present disclosure discloses a method of leaching precious metals from a precious metal-containing substance, the method comprising immersing the substance in a solvent media, the solvent media comprising:
a) a solvent comprising MMB;
b) one or more oxidizing agent(s) such as chlorine, bromine, bromate, perbromate salts, hydrogen peroxide, chlorate, chlorite salts, perchlorate salts; and
c) a halogen salt such as chloride alkali metal salts, bromide alkali metal salts, preferably lithium bromide salt.

The leaching method is performed by immersing the precious metal-containing substance in a solvent media containing the solvent, the halogen salt and the oxidizing agent or agents. The resulting mixture is agitated to conduct an agitated leaching process. Subsequently, in the resulting mixture, the precious metals are oxidized and form precious metal salts, which are soluble in the solvent media.

Soluble halogens in the solvent media will react with the oxidizing agents directly to create a stronger oxidant (e.g., bromine) to oxidize precious metals and convert them to charged ions and subsequently produce soluble precious metal salts in the solvent media. To achieve a successful dissolution of the precious metals into the solvent media, the preferred amount of the solution oxidation reduction potential (ORP) should be above 600 mV as anticipated against a standard calomel electrode (SCE). This ORP amount is enough to convert the precious metals into an ionic form to generate a soluble complex with halide ions present in the solution. The solvent media selectively dissolves the resulting precious metal salts and leaves other elements, metals, and materials behind in solid form.

Thus, as precious metals are dissolved in the solvent media, solid residues, which are not soluble in the solvent media, are created, and hence, the solvent media turns into a slurry containing a liquid precious metal-pregnant solution and the solid residues. Ideally, the resulting solid residues are substantially free of precious metals.

Subsequently, the leaching stage includes a filtering step wherein the slurry is filtered to separate the pregnant solution from the solid residues. The solid residues may be washed using an organic solvent or water, for example. The pregnant solution and the solid residues may be weighed and assayed using, for example, X-ray fluorescence (XRF) spectrometry. Completing the mass balance can provide values for precious metal recovery and dissolution efficiency of the solvent. In the examples below, some extraction values are presented.

The leaching solution temperature, pH, stirring speed, pulp density (which is the amount of solid precious metal-containing substance in the solution), OPR, and the time for which the precious metal-containing substance is in contact with the solvent media, are important parameters that should be monitored or controlled through the leaching process. The impact of some of these parameters on precious metal extraction is described in the provided examples.

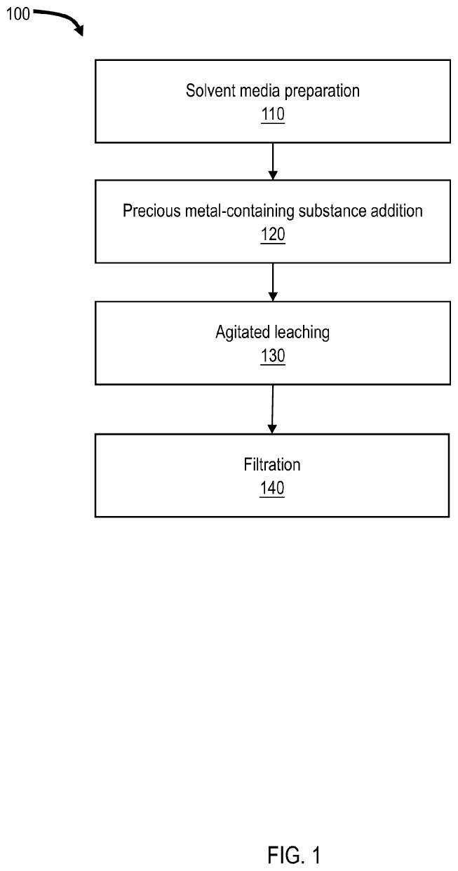

Referring to FIG. 1, shown therein is a flowchart of a precious metal leaching process 100. In the first step 110, the solvent media is prepared by mixing the MMB-containing solvent, halogen salts, and oxidizing agents.

The solvent is an alcohol-based miscible solvent which includes MMB and may or may not include water. The MMB may be concentrated or diluted in water. Water concentration may be chosen in the range of 0% to 99%, preferably in the range of 40% to 70% and more preferably in the range of 45% to 55% w/w of the solvent mass with the remainder of the solvent being MMB. The solvent can dissolve the oxidants, the halogen salts, and precious metal-containing substances through chemical reactions taking place in the solvent media. On the other hand, the solvent itself is stable enough to not react with reagents and oxidants and can act only as the host media to dissolve all the reagents and desirable products such as precious metal salts. Utilizing the solvent instead of water-acid based media, maximizes solubility of reagents and oxidants, which will increase the kinetics of the reactions and efficiency of the leaching process 100. Also, the disclosed solvent could maximize the solubility of the target precious metals and their salts which will increase the recoveries and extraction efficiency.

The oxidizing agents include but are not limited to chlorine, bromine, bromate and perbromate salts, hydrogen peroxide, chlorate and chlorite salts, perchlorate salts. Preferably the oxidizing agent is one of: lithium bromate, lithium perbromate, lithium chlorate, lithium perchlorate, and lithium chlorite. The concentration of the oxidizing agent is not restricted and may vary according to the precious metal-containing substance but may be in the range of 0.1 to 100 grams per liter and preferable in the range of 2 to 20 grams per liter of the solvent media.

Regarding the halogen salts, the alkali and alkaline forms are preferred, such as sodium chloride, potassium chloride, sodium bromide, potassium bromide, and lithium bromide. The amount of soluble halide salts must be sufficient to generate soluble precious metal halide complexes and also maintain the ORP high enough to maintain the precious metal ionic form in the solvent media. The amount of halide ion preferably should be in the range of 0.1 to 1.0 molar and preferably in the range of 0.2 to 0.5 molar.

Within the solvent media, the oxidizing agents react with the halogen salts and this in-situ oxidation results in the creation of halogen elements in the solvent media which are strong oxidizing agents for the precious metals.

The resulting solvent media is stable enough to host the reactions taking place in the media and do not to involve in the oxidizing agent-halogen salt oxidation reactions and the reactions that occur after the addition of the precious metal-containing substance in step 120. Also, the solvent can maximize the solubility of reagents and oxidants and reactions products which will increase the efficiency of extraction while minimizing the off-gassing and evaporation of chemicals, which will decrease the cost of extraction dramatically. The solvent media increases the solubility and stability of oxidants and reagents in their oxidizing phase, which subsequently will facilitate controlling the amount of oxidants required in the leaching process and will help develop in-situ and gradual oxidation, which will minimize chemical consumption in the process and will reduce the precious metal extraction costs dramatically.

In step 120, the precious metal-containing substance, preferably in powdered form, is added to, or submerged into, the prepared solvent media in a reactor/reaction vessel.

In step 130, the mixture of the solvent media and the precious metal-containing substance is agitated, for example, using a magnet stirrer, and the actual leaching reactions take place. Depending on the size/amount of the precious metal containing substance, the solvent media may be agitated for 0.5 to 48 hours and preferably for 8 to 24 hours. As mentioned before, the presence of existing oxidants in the solvent media causes precious metal oxidation and the formation of precious metal salts which are soluble in the solvent media. The solvent media selectively dissolves the resulting precious metal salts and leaves other elements, metals, and materials behind in solid form.

In step 140, the leaching slurry is filtered, and the liquid solution and solid residues are separated from each other. The slurry is passed through a plastic filter (e.g., polypropylene or polyvinyl chloride) having a pore size between 1-25 microns and preferably between 5-10 microns. The flow of the slurry through the filter may be by gravity, but preferably vacuum or positive pressure is used.

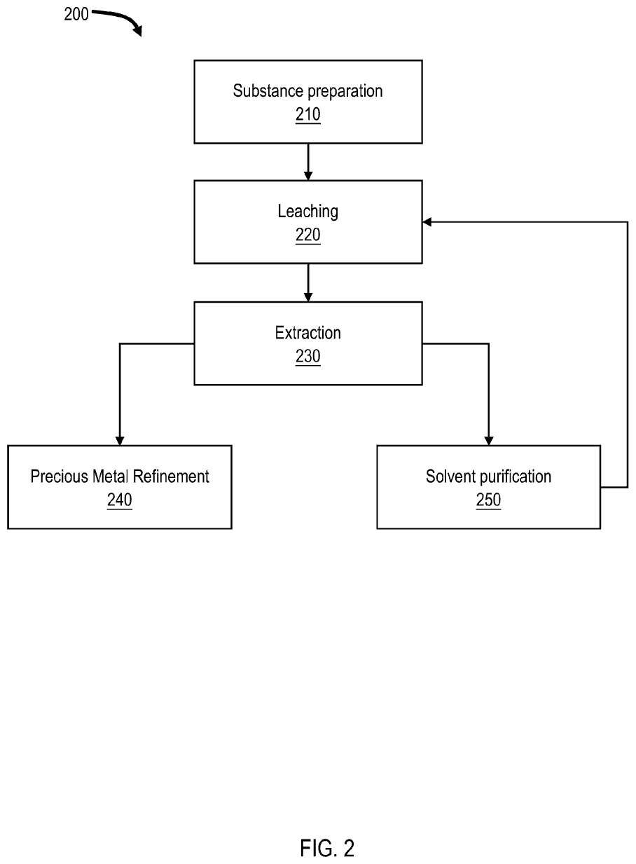

The leaching method 100 can be part of a precious metal extraction process. FIG. 2 shows a flowchart of a precious metal extraction process 200. The extraction process 200 comprises a substance preparation stage 210, a leaching stage 220, and an extraction stage 230.

In the substance preparation stage 210, one or more precious metal-containing substances, such as mining extracts or spent automotive catalysts, are prepared, for example, by being ground to fine powders. In the leaching stage 220, the prepared substance is added to the solvent media to leach the precious metal(s) and obtain a precious metal pregnant solution. In the extraction stage 230, the precious metal is extracted from the pregnant solution.

The precious metal extraction process 200 may further include a precious metal refinement stage 240, wherein the precious metal is refined, and a solvent purification stage 250, wherein the remaining solution/solvent is purified and recycled to be reused in the leaching stage 220. The recycled solvent can be reused to dissolve precious metals from new precious metal-containing substances.

The methods of this invention is explained by the following examples in more detail. It should be understood that the examples do not restrict the scope of this invention.

### Referential Example—Leach Test

An agitated leaching and extraction process was conducted in a round bottom flask placed in a thermostatically controlled water bath or beaker with a magnetic stirrer. The halogen salts were dissolved in the solvent before pouring it into the flask. Once the solvent media reached a predetermined temperature between 20° C.-90° C. and preferably between 40° C.-70° C., the precious metal-containing samples were added. The RPM of the magnetic stirrer was maintained at about 600, and the solvent media pH was maintained between 1 to 4. The pulp density was maintained under 10% w/w in all tests. The test duration varied from a few hours to several days. There is no waste for reagents and solvent because the solution is continuously used (which makes the process unique and noble). After leaching, the pregnant solution and tailings (i.e., the solid residues) were weighed and assayed using XRF methodology. All the recoveries in the examples are calculated based on the precious metals extracted from the solids and precious metals left in the solid residues. For example, if the head sample contains 100 grams of precious metals, and 99 grams are extracted with 99% recovery, it means 1 gram of precious metals is left in the solid residue. Completing the mass balance provided values of recovery and efficiency of the solvent, which is presented in the examples.

When adding an oxidant such as lithium bromate to the bromide salt, preferably lithium bromide dissolved into the solvent, the bromide will be oxidized to bromine. The reactions are as below:

BrO₃−+5Br−+6H++10e−→3Br₂+3H₂O E̊=1.49 V (1)

The produced bromine is a strong oxidizing agent which will be dissolved into the solvent. By reducing pH and adding excess acid to the reaction, bromine will be the predominant component. As the bromine is soluble in the solvent, it will stay as bromine through the whole reaction and will not hydrolyze the solution to generate hydrobromic acid, which is a strong acid. Therefore, the pH will be maintained around 4-5, and the extraction will take place in a safe environment. To be able to decrease the pH and to maximize the efficiency, acid needs to be added to the solvent. The acid may be diluted or concentrated sulfuric acid, hydrochloric acid, acetic acid or citric acid.

When pH is decreased to lower than 4 and preferably about 1-3, the oxidizing strength of bromine is suitable for PGMs dissolution. When platinum and palladium, or other PGMs are reacted with the bromine, the PGMs bromide salts will be produced, which is highly soluble into the solvent media.

Pt+2Br₂→PtBr₄ (2)

Pt+3Br₂→PtBr₆ (3)

Pd+2Br₂→PdBr₄ (4)

Pd+3Br₂→PdBr₆ (5)

### EXAMPLE 1

A sample of a very high-grade spent catalyst substance containing PGMs was ground to a grind size of P100, 125 microns (meaning 80% of the particles are less than 75 microns in size and 100% of the particles are less than 125 microns in size) to increase the overall surface area of the PMG-containing substance to increase leaching reactions. The sample was riffle split into two homogenous samples. Each sample was used for two leach tests as explained in the Referential Example above, with the same conditions, except the solution. One sample was soaked in Aqua Regia (3:1 hydrochloric acid and nitric acid), as one of the strongest lixiviants, and the other sample was leached in the solvent media of the current disclosure.

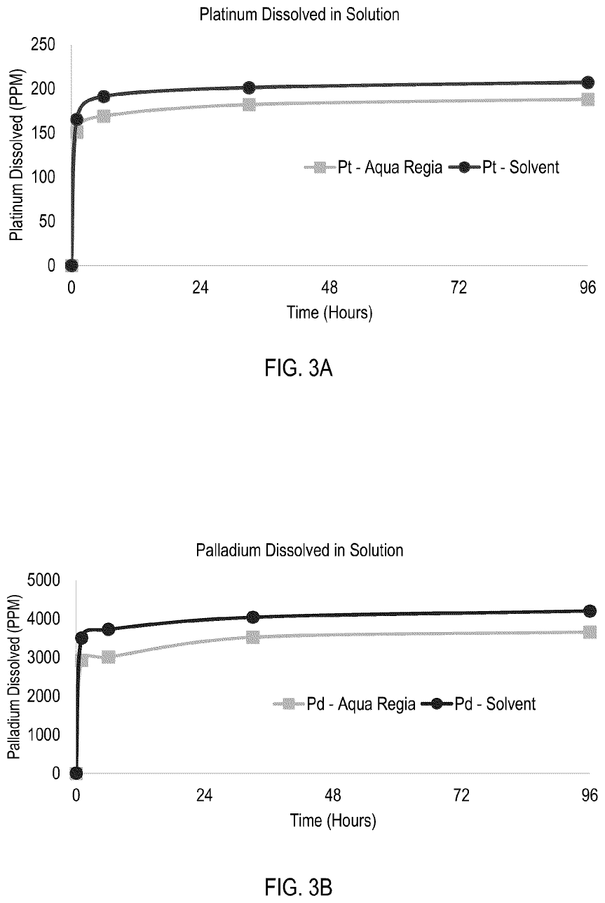

The tests were conducted for 96 hours at room pressure and temperature with 5% w/w pulp density for both tests. The amount of dissolved PGMs into the solution was measured at 1, 6, 33 and 96 hours by inductively coupled plasma optical emission spectroscopy (ICP-OES). The results are shown in FIGS. 3A, 3B and 3C for Pt, Pd, and Rd, respectively. In the first 6 hours: 200 ppm of platinum dissolved in the solvent media compared to 170 ppm in the Aqua Regia; 3800 ppm of palladium dissolved in the solvent media compared to 3200 ppm dissolved in the Aqua Regia; and 410 ppm of Rhodium dissolved in the solvent media compared to 320 ppm dissolved in the Aqua Regia. The results show that the disclosed solvent has higher leaching kinetics and dissolved higher amounts of the precious metals into the solution compared to Aqua Regia.

### EXAMPLE 2

A sample of a spent catalyst containing PGMs was pulverized to P100, 125 microns. The sample was leached as explained in the Referential Example above, using the disclosed solvent. The sample was assayed using an XRF device. The results showed that the sample contained 1850 ppm of palladium, 207 ppm of platinum and 350 ppm of Rh. The leach test was performed with 10% w/w pulp density for 6 hours, one at room temperature and the other at 50° C. The recoveries for Pd, Pt and Rh are shown in Table 1 for both temperatures. There is a significant increase in the recovered Pt and Rh at 50 degrees compared to room temperature. There is a modest increase in the amount of Pd recovered at 50 degrees compared to room temperature, as Pd is generally easier to extract.

TABLE 1

| | Room Temp (~21° C.) | 50° C. |
|---|---|---|
| Pt | 65% | 99% |
| Pd | 89% | 95% |
| Rh | 20% | 65% |

### EXAMPLE 3

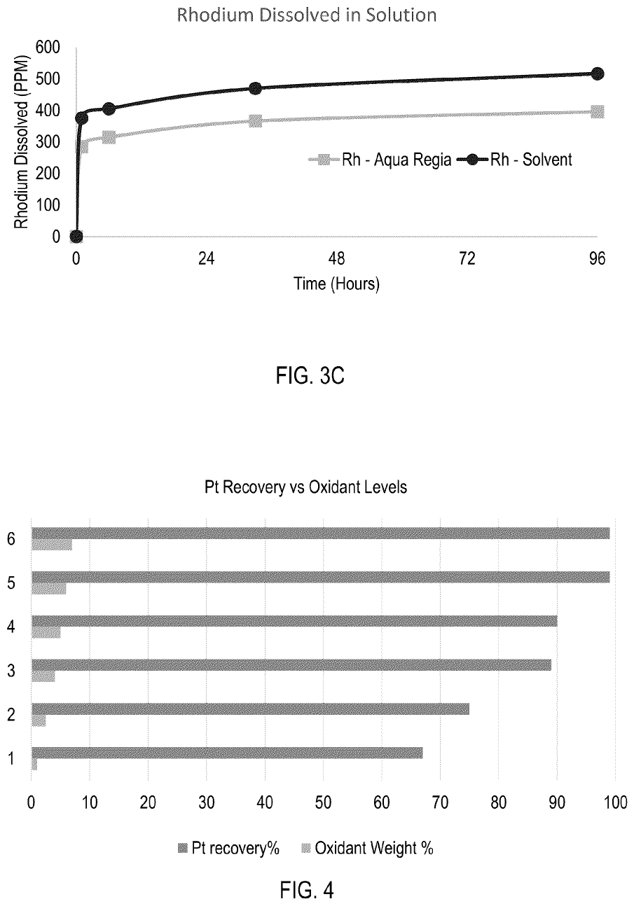

A refinery spent catalyst containing high-grade Platinum levels was used as a sample. The sample was pulverized to a grind size of P100, 125 microns. The effect of oxidizing agent levels in the solvent media (by weight %) on solvent efficiency was studied. All the tests were performed as explained in the Referential Example and at 45° C. for 12 hours with 5% w/w pulp density. FIG. 4 shows the results of this example. As it is shown in FIG. 4, higher oxidant levels in the solvent media resulted in higher dissolved amounts of platinum.

### EXAMPLE 4

Various samples of spent catalyst substances containing PGMs loaded on different matrices including Zirconia-Titania, Silicon Carbide, and mixed matrix (Silica, Alumina, Cerium Oxide, Silicon Carbide) were leached as explained in the Referential Example and using the disclosed solvent. The samples were leached in a commercialized reactor in pilot plant scale with an operational capacity of 300 US gallons. 250 gallons of solvent media was mixed with about 100 kg of precious metal-containing substance. The samples were assayed using microwave acid digestion following by inductively coupled plasma mass spectroscopy (ICP-MS). The leach pilot tests were performed with 10% w/w pulp density for 24 hours at 75° C. The samples characterizations and recoveries for Pd, Pt and Rh are shown in table below.

TABLE 2

| | | Pd | Pt | Rh |
|---|---|---|---|---|
| Sample | Matrix | Recovery % | Recovery % | Recovery % |
| 1 | Zirconia-Titania | N/A | 99.1 | N/A |
| 2 | Silicon Carbon | N/A | 99.3 | N/A |
| 3 | Silicon Carbon | 98.5 | 99.9 | N/A |
| 4 | Silicon Carbon | 98.3 | 99.2 | N/A |
| 5 | Mixed | 99.9 | 99.9 | 97.5 |
| 6 | Mixed | 98.6 | 99.6 | 85.9 |

While specific embodiments have been described and illustrated, such embodiments should be considered illustrative only and not as limiting the disclosed embodiments. It will be appreciated that other compositions and methods may be within the scope of the claims as interpreted by one of skill in the art.

1. A solvent media for leaching precious metals, the solvent media comprising:
a solvent comprising 3-methoxy-3-methyl-1-butanol (MMB);
an oxidizing agent; and
a halogen salt.

2. The solvent media of claim 1, wherein the solvent further comprises water in 45% to 55% w/w.

3. The solvent media of claim 1, wherein a concentration of the oxidizing agent is 0.1-100 g/L.

4. The solvent media of claim 1, wherein the oxidizing agent is selected to oxidize bromide.

5. The solvent media of claim 1, wherein the oxidizing agent is one of: chlorine, bromine, bromate, perbromate salt, hydrogen peroxide, chlorate and chlorite salts.

6. The solvent media of claim 1, wherein a concentration of the halogen salt is 0.1-1.0 molar.

7. The solvent media of claim 1, wherein the halogen salt is one of: an alkali metal bromide salt and an alkali chloride salt.

8. The solvent media of claim 7, wherein the halogen salt is one of: lithium bromide, sodium bromide and potassium bromide.

9. The solvent media of claim 1, having an oxidization reduction potential of >600 mV.

10. The solvent media of claim 1, having a pH of 1 to 4, and more preferably having a pH of 1 to 3.

11. A method for leaching and extracting a precious metal from a substance comprising the metal, the method comprising:
preparing a solvent media having an oxidization reduction potential of >600 mV and a pH of 1 to 4, the solvent media comprising:
a solvent comprising 3-methoxy-3-methyl-1-butanol;
an oxidizing agent; and
a halogen salt;
adding the substance to the solvent media, wherein the substance in the solvent media forms of a slurry having a pulp density of no more than 25% w/w, the slurry comprising a precious metal-pregnant solution and insoluble impurities;
filtering the insoluble impurities from the slurry; and
extracting the precious metal from the precious metal-pregnant solution.

12. The method of claim 11, further comprising grinding or pulverizing the substance.

13. The method of claim 11, further comprising agitating the slurry for up to 96 hours.

14. The method of claim 11, further comprising heating the slurry to a temperature of 50° C.-75° C.

15. The method of claim 11, further comprising adding an acid to the slurry.

16. The method of claim 11, further comprising purifying a remaining solution, after extracting the precious metal from the precious metal-pregnant solution, to generate a purified solvent.

17. The method of claim 16, further comprising, adding the purified solvent to the solvent media.

18. What is claimed is compositions and methods as generally and as specifically described herein.
